(19) United States
(12) Patent Application Publication
(10) Pub. No.: US 2016/0127433 A1
(43) Pub. Date: May 5, 2016

(54) BROADCASTING AND MANAGING BROADCASTS USING A TELEPHONY CONFERENCE PLATFORM

(71) Applicant: RADIODASH, LLC, New York, NY (US)

(72) Inventors: Baruch Herzfeld, Brooklyn, NY (US); Ney Alexandre Alves Frota, Rio de Janeiro (BR); Gene Cohen, Nyack, NY (US); Joseph Monti, Pittsfield, MA (US)

(21) Appl. No.: 14/930,055

(22) Filed: Nov. 2, 2015

Related U.S. Application Data
(60) Provisional application No. 62/073,637, filed on Oct. 31, 2014.
(60) Provisional application No. 62/173,660, filed on Jun. 10, 2015.
(60) Provisional application No. 62/232,879, filed on Sep. 25, 2015.

(51) Int. Cl. H04L 29/06; H04M 3/56

(52) U.S. Cl. CPC H04L 65/4038; H04M 3/567; H04M 3/568; H04L 65/1023; H04L 65/4076

(57) ABSTRACT

A system for managing a broadcasting platform includes a gateway device that broadcasts a broadcast media stream to a plurality of user devices. Each user device is connected to a primary conference room of a telephony conference platform of the gateway device via a first user telephony connection. The gateway device receives a user signal from a first user device through the telephony conference platform via a second user telephony connection associated with the first user device, between the first user device and a secondary conference room of the telephony conference platform. The gateway device mixes the user signal into the broadcast media stream in real time using the telephony conference platform and broadcasts the broadcast media stream comprising the user signal to the plurality of user devices connected to the primary conference room in real time, excluding the first user device.

### RELATED APPLICATIONS

This application claims priority to and the benefit of provisional patent application Ser. No. 62/073,637, filed on Oct. 31, 2014, entitled “SCALABLE BROADCAST PLATFORM,” the disclosure of which is hereby incorporated herein by reference in its entirety.

This application claims priority to and the benefit of provisional patent application Ser. No. 62/173,660, filed on Jun. 10, 2015, entitled “SCALABLE BROADCAST PLATFORM,” the disclosure of which is hereby incorporated herein by reference in its entirety.

This application claims priority to and the benefit of provisional patent application Ser. No. 62/232,879, filed on Sep. 25, 2015, entitled “SCALABLE BROADCAST PLATFORM” the disclosure of which is hereby incorporated herein by reference in its entirety.

### TECHNICAL FIELD

The technology of this disclosure relates generally to broadcasting and managing broadcasts, and more specifically to broadcasting and managing broadcasts using a telephony conference platform.

### BACKGROUND

The field of broadcasting has expanded from terrestrial broadcasting to a limited geographical area to network and internet-based broadcasting that has a much wider geographical reach. However, conventional network and internet-based broadcast hosts are not able to easily interact with listeners, such as through listener calls, and other two-way interactions. Accordingly, there is a need for a scalable broadcast platform that also allows interaction between broadcast hosts and listeners or other users.

### SUMMARY

In one embodiment, a system for managing a broadcasting platform, and related components, devices, and methods are disclosed. The system comprises a gateway device having a processor broadcasting a broadcast media stream to a plurality of user devices. Each user device is connected to a primary conference room of a telephony conference platform of the gateway device via a first user telephony connection. The gateway device next receives a user signal from a first user device through the telephony conference platform via a second user telephony connection associated with the first user device. The second user telephony connection is a connection between the first user device and a secondary conference room of the telephony conference platform. The gateway device mixes the user signal into the broadcast media stream in real time using the telephony conference platform and broadcasts the broadcast media stream comprising the user signal to the plurality of user devices connected to the primary conference room in real time, excluding the first user device.

One advantage of this arrangement is that a telephony conference platform can be used to mimic the functionality of a traditional terrestrial radio program, such as allowing a user to call in and interact with the program host “on air.” By routing the user signal through a conference room separate from the conference room providing the broadcast media stream, interference and feedback from the broadcast media stream can be avoided, and network resources may be conserved.

According to one embodiment, a method of managing a broadcasting platform is disclosed. The method comprises broadcasting, by a gateway device having a processor, a broadcast media stream to a plurality of user devices connected to a first conference room of a telephony conference platform of the gateway device via a plurality of first user telephony connections each associated with one of the plurality of user devices. The method further comprises receiving, through the telephony conference platform of the gateway device, a user signal from a first user device of the plurality of user devices via a second user telephony connection associated with a first user device between the first user device and a second conference room of the telephony conference platform. The method further comprises mixing, through the telephony conference platform of the gateway device, the user signal into the broadcast media stream in real time. The method further comprises broadcasting, by the gateway device, the broadcast media stream comprising the user signal to the plurality of user devices connected to the first conference room via the plurality of user telephony connections in real time, excluding the first user device.

According to another embodiment, a method of managing a broadcasting platform is disclosed. The method comprises directing, by a host device having a processor, a gateway device to broadcast a broadcast media stream to a plurality of user devices connected to a first conference room of a telephony conference platform of the gateway device via a plurality of first user telephony connections each associated with one of the plurality of user devices. The method further comprises receiving, by the host device through the telephony conference platform of the gateway device, a user signal from a first user device of the plurality of user devices via a second user telephony connection associated with a first user device between the first user device and a second conference room of the telephony conference platform. The method further comprises directing, by the host device, the telephony conference platform of the gateway device to mix the user signal into the broadcast media stream in real time. The method further comprises directing, by the host device, the gateway device to broadcast the broadcast media stream comprising the user signal to the plurality of user devices connected to the first conference room via the plurality of user telephony connections in real time, excluding the first user device.

According to another embodiment, a gateway device is disclosed. The gateway device comprises a processor, and a telephony conference platform in communication with the processor. The gateway device is configured to broadcast a broadcast media stream to a plurality of user devices connected to a first conference room of a telephony conference platform of the gateway device via a plurality of first user telephony connections each associated with one of the plurality of user devices. The gateway device is further configured to receive a user signal from a first user device of the plurality of user devices via a second user telephony connection associated with a first user device between the first user device and a second conference room of the telephony conference platform. The gateway device is further configured to mix the user signal into the broadcast media stream in real time. The gateway device is further configured to broadcast the broadcast media stream comprising the user signal to the plurality of user devices connected to the first conference room via the plurality of user telephony connections in real time, excluding the first user device.

According to another embodiment, a non-transitory computer-readable medium is disclosed. The non-transitory computer-readable medium comprises computer-readable instructions for performing a method of managing a broadcasting platform. The method comprises broadcasting, by a gateway device having a processor, a broadcast media stream to a plurality of user devices connected to a first conference room of a telephony conference platform of the gateway device via a plurality of first user telephony connections each associated with one of the plurality of user devices. The method further comprises receiving, through the telephony conference platform of the gateway device, a user signal from a first user device of the plurality of user devices via a second user telephony connection associated with a first user device between the first user device and a second conference room of the telephony conference platform. The method further comprises mixing, through the telephony conference platform of the gateway device, the user signal into the broadcast media stream in real time. The method further comprises broadcasting, by the gateway device, the broadcast media stream comprising the user signal to the plurality of user devices connected to the first conference room via the plurality of user telephony connections in real time, excluding the first user device.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a schematic diagram of a system for broadcasting via a telephony conference platform, according to an embodiment;

FIG. 2 is a flowchart illustrating a method of broadcasting via a telephony conference platform using the system of FIG. 1, according to an embodiment;

FIG. 3 is a flowchart illustrating a method of managing a broadcasting platform using the system of FIG. 1, according to an embodiment;

FIG. 4 illustrates a schematic diagram of a system for managing a broadcasting platform, according to another embodiment;

FIG. 5 is a flowchart illustrating a method of managing a broadcasting platform using the system of FIG. 1, according to an embodiment;

FIG. 6 illustrates a schematic diagram of a system for managing a broadcasting platform, according to another embodiment;

FIG. 7A illustrates a user interface for a broadcast host device for any of the systems of FIGS. 1, 4, and 6, according to an embodiment;

FIG. 7B illustrates a settings interface for the user interface of FIG. 7A for the broadcast host device according to an embodiment;

FIG. 7C illustrates a user interface for a user device for any of the systems of FIGS. 1, 4, and 6, according to an embodiment;

FIG. 7D illustrates the user interface FIG. 7A for the broadcast host device receiving a connection request from a user device employing the user interface of FIG. 7C according to an embodiment;

FIG. 7E illustrates the user interface FIG. 7A for the broadcast host device placing the user signal received via the listener device user interface of FIG. 7C into the broadcast media stream according to an embodiment; and

FIG. 8 illustrates a block diagram for a computing device for use as a gateway device, host device, or user device with one of the systems of FIGS. 1, 4, and 6, according to an embodiment.

The foregoing summary, as well as the following detailed description of certain embodiments, will be better understood when read in conjunction with the appended drawings. For purposes of illustration, certain embodiments are shown in the drawings. It should be understood, however, that the embodiments are not limited to the arrangements and instrumentality shown in the attached drawings.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first conference room” and “second conference room,” and does not imply a priority, a type, an importance, or other attribute, unless otherwise stated herein.

In one embodiment, a method of managing a broadcasting platform is disclosed. The method comprises a gateway device having a processor broadcasting a broadcast media stream to a plurality of user devices. Each user device is connected to a primary conference room of a telephony conference platform of the gateway device via a plurality of first user telephony connections. The gateway device next receives a user signal from a first user device through the telephony conference platform via a second user telephony connection associated with the first user device. The second user telephony connection is a connection between the first user device and a secondary conference room of the telephony conference platform. The gateway device mixes the user signal into the broadcast media stream in real time using the telephony conference platform and broadcasts the broadcast media stream comprising the user signal to the plurality of user devices connected to the primary conference room in real time, excluding the first user device.

One advantage of this arrangement is that a telephony conference platform can be used to mimic the functionality of a traditional terrestrial radio program, such as allowing a user to call in and interact with the program host “on air.” By routing the user signal through a conference room separate from the conference room providing the broadcast media stream, interference and feedback from the broadcast media stream can be avoided, and network resources may be conserved.

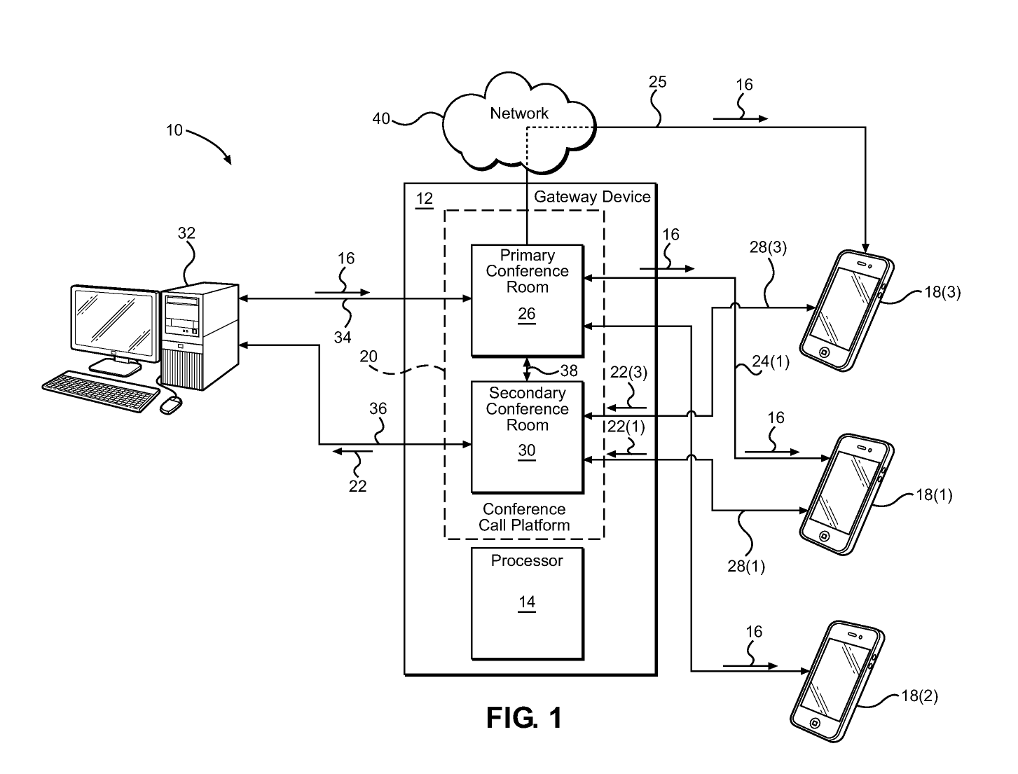

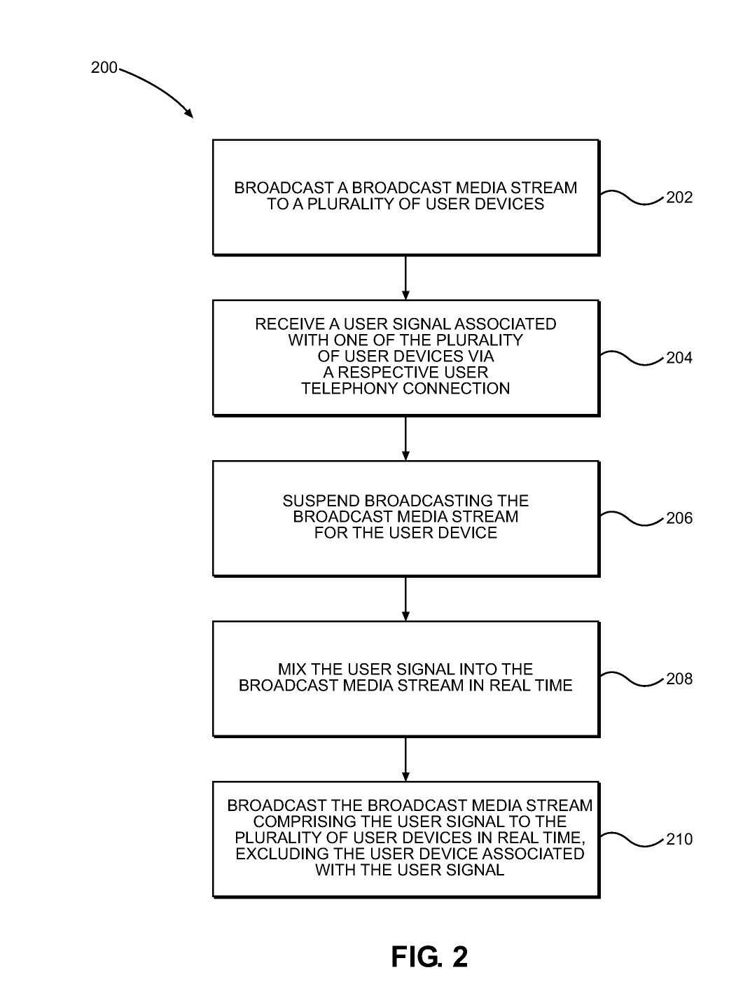

In this regard, FIG. 1 illustrates a schematic diagram of a system 10 for broadcasting via a telephony conference platform, according to an embodiment. Reference is also made to corresponding portions of the method 200 illustrated by the flowchart of FIG. 2. A gateway device 12 having a processor 14 broadcasts a broadcast media stream 16 to a plurality of user devices 18 (Block 202). The gateway device 12 includes a telephony conference platform 20, and the gateway device 12 receives a user signal 22, such as a media or audio (e.g., voice) signal, through the telephony conference platform 20 from one of the user devices 18(1) via a user telephony connection 24 between the user device 18 and the telephony conference platform 20 (Block 204). In some embodiments, the broadcast media stream 16 may also be received by the user device 18 via the user telephony connection 24. In other embodiments, the broadcast media stream 16 is received via an internet protocol (IP) connection 25 that is separate from the user telephony connection 24. In some embodiments, the user telephony connection 24 and IP connection 25 may be a common IP telephony connection.

The gateway device 12 next suspends the broadcast media stream 16 for the user device 18(1) associated with the user signal 22 (Block 206), and mixes the user signal 22 into the broadcast media stream 16 in real time using the telephony conference platform 20 (Block 208). The gateway device 12 then broadcasts the broadcast media stream 16 comprising the user signal 22 to the plurality of user devices in real time, except for the user device 18(1) associated with the user signal 22 (Block 210). As noted above, an advantage of this arrangement is that a telephony conference platform can be used to mimic the functionality of a traditional terrestrial radio program, such as allowing a user to call in and interact with the program host “on air.”

In some embodiments, the gateway device 12 may comprise a plurality of gateway devices interconnected by a network, such as a network 40. The network 40 may be a local network or a cloud-based network, for example. Broadcasting the broadcast media stream 16 may also be accomplished via the network 40 (e.g., using IP connections) and/or via the telephony conference platform 20 using user telephony connections 24.

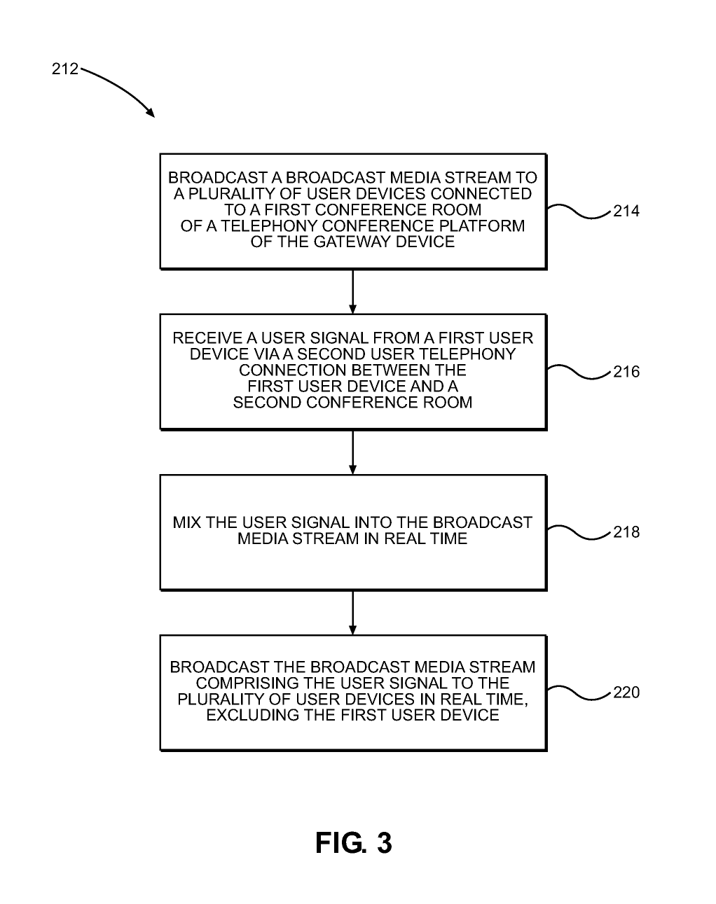

The system 10 of FIG. 1 may also be configured for managing a broadcasting platform, according to an embodiment. In this regard, reference is made to corresponding portions of the method 212 illustrated by the flowchart of FIG. 3. As with the method of facilitating interaction between the telephony conference platform 20 and user devices 18 discussed above, the gateway device 12 broadcasts the broadcast media stream 16 to the plurality of user devices 18 (Block 214). In this embodiment, each user device 18 is connected to a primary conference room 26 of a telephony conference platform 20 of the gateway device 12 via a first user telephony connection 24. The gateway device 12 next receives a user signal 22 from a first user device 18(1) through the telephony conference platform 20 via second a user telephony connection 28(1) between the first user device 18(1) and a secondary conference room 30 of the telephony conference platform 20 (Block 216), with a broadcast host device 32 connected to the primary conference room 28 via a primary host telephony connection 34, and to the secondary conference room 30 via a secondary host telephony connection 36, for example. The gateway device 12 mixes the user signal 22 into the broadcast media stream 16 in real time using the telephony conference platform 20 (Block 218) and broadcasts the broadcast media stream 16 comprising the user signal 22 to the plurality of user devices 18 connected to the primary conference room 26 in real time, excluding the first user device 18(1) (Block 220).

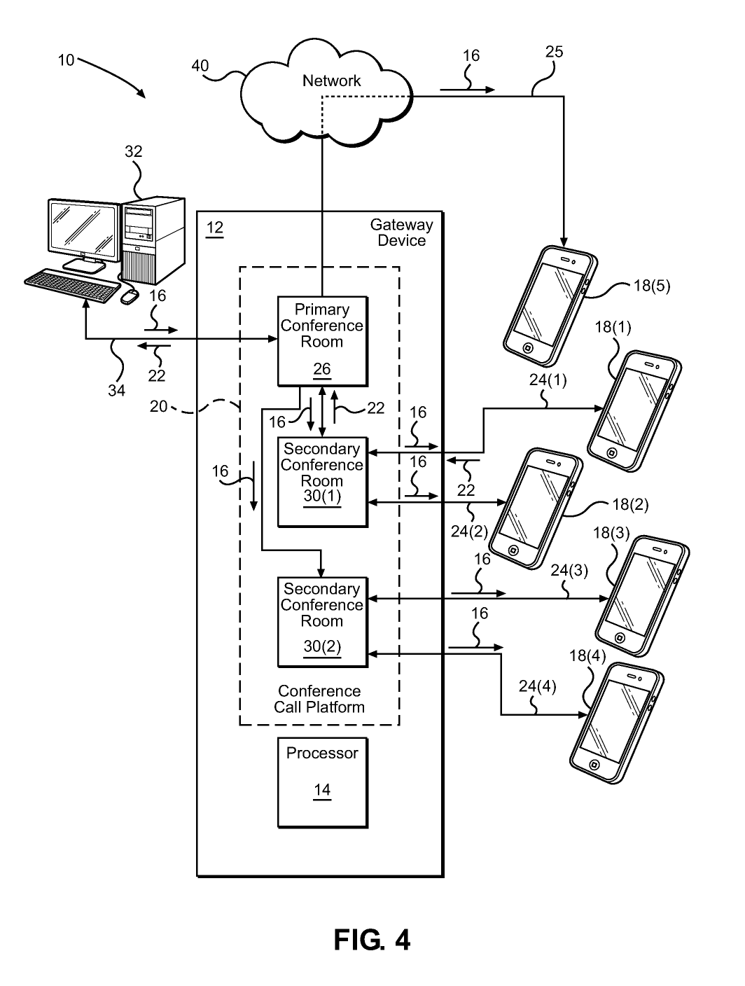

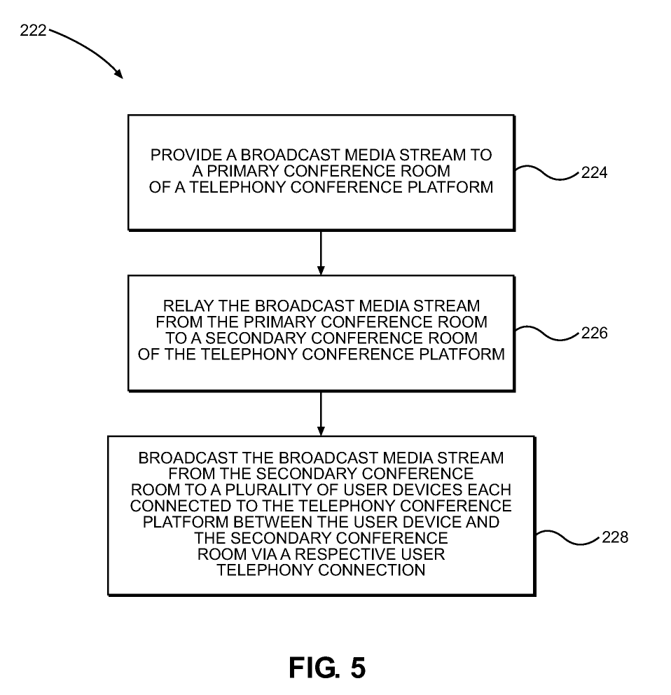

These features can also be used to distribute broadcast load across a number of conference rooms, which may facilitate dynamic scaling of the broadcast platform. In this regard, FIG. 4 illustrates a schematic diagram of a system 10 for managing a broadcasting platform, according to an embodiment. Reference is also made to corresponding portions of the method 222 illustrated by the flowchart of FIG. 5. The method comprises the gateway device 12 having the processor 14 providing the broadcast media stream 16 to the primary conference room 26 of the telephony conference platform 20 of the gateway device 12 (Block 224). The gateway device 12 relays the broadcast media stream 16 from the primary conference room 26 to the secondary conference room 30 of the telephony conference platform 20 (Block 226). The gateway device 12 next broadcasts the broadcast media stream 16 from the secondary conference room 30 to the plurality of user devices 18. Each user device is connected to the telephony conference platform 20 via the respective user telephony connection 24 between the user device 18 and the secondary conference room 30 (228).

One advantage of this arrangement is that a telephony conference platform can be used to mimic the functionality of a traditional terrestrial radio program, such as allowing scaling of a telephony conference platform to effectively broadcast a program to a large number of users. By routing the broadcast media stream through multiple conference rooms, the load on each individual conference room can be reduced, and the broadcast platform can be effectively scaled up to provide programming to a larger number of users than are normally associated with a traditional conference call arrangement.

In some embodiments, different conference rooms 26, 30 may have different roles and may be disposed in different regions of the telephony conference platform 20, and may be disposed on a separate gateway device 12 interconnected by a network, such as network 40. In one embodiment, all callers are processed through a series of at least two conference rooms 26, 30, with all listeners who want to listen to a particular broadcast media stream 16 being placed in a common conference room 26 on mute. If a listener wants to call in to the radio program, the caller initiates a request to the telephony conference platform 20, which triggers a second call to another conference room 30 of the telephony conference platform 20, where the user has permission to talk so that a broadcast operator is able to receive the incoming call, and mix the call into the broadcast media stream 16 at the first conference room 26, as desired.

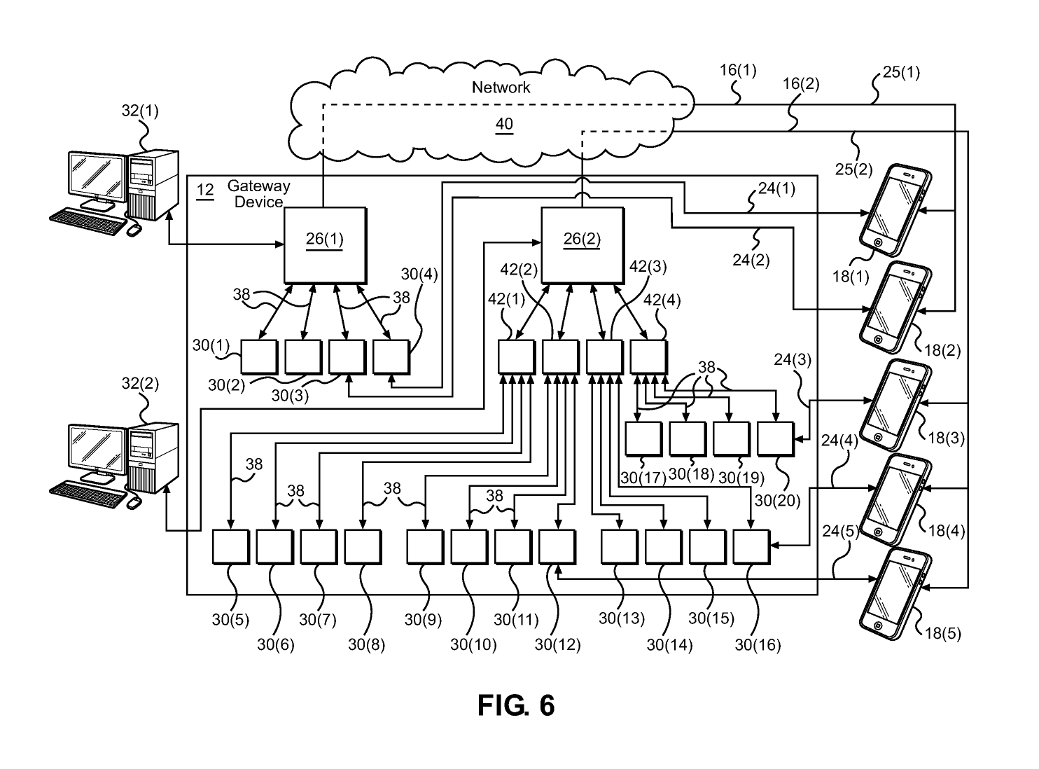

In some embodiments, a hierarchy of conference rooms within the telephony conference platform can be used, in order to manage connection load and to permit effective scaling of the telephony conference platform to accommodate a large number of broadcast hosts and users connecting simultaneously for a single program. In this regard, FIG. 6 illustrates a schematic diagram of a system for managing a broadcasting platform, according to another embodiment, in which the primary conference room 26 connects to the plurality of secondary conference rooms 30 in a hierarchical tree, so that no one conference room 26, 30 is overwhelmed with connections. For example, in this embodiment, the broadcast host device 32(1) hosts a program via primary conference room 26(1). Primary conference room 26(1) provides the broadcast media stream 16(1) via the network 40 connection, and via the telephony conference platform 20 (not shown) of gateway device 12. The primary conference room 26(1) is connected to the plurality of secondary conference rooms 30(1)-30(4) via respective conference room interconnections 38. In this embodiment, for example, the user device 18(1) is connected to the telephony conference platform 20 via the user telephony connection 24(1) connected to the secondary conference room 30(3), and the user device 18(2) is connected to the telephony conference platform 20 via the user telephony connection 24(2) connected to the secondary conference room 30(3).

In some embodiments, multiple layers or tiers of conference rooms 30 may be used to distribute the connection load. For example, in FIG. 6, the broadcast host device 32(2) hosts a program via the primary conference room 26(2). The primary conference room 26(2) provides the broadcast media stream 16(2) via the network 40 connection, and via the telephony conference platform 20. The primary conference room 26(2) is indirectly connected to the plurality of secondary conference rooms 30(5)-30(20) through a plurality of intermediate conference rooms 42(1)-42(4), with the conference rooms 26, 30, 42 connected to each other via the plurality of conference room interconnections 38.

In this embodiment, for example, the user device 18(3) is connected to the telephony conference platform 20 via the user telephony connection 24(3) connected to the secondary conference room 30(20), which is connected to the primary conference room 26(2) through the intermediate conference room 42(4). Similarly, the user device 18(4) is connected to the telephony conference platform 20 via the user telephony connection 24(4) connected to the secondary conference room 30(16), which is connected to the primary conference room 26(2) through the intermediate conference room 42(3), and the user device 18(5) is connected to the telephony conference platform 20 via the user telephony connection 24(5) connected to the secondary conference room 30(12), which is connected to the primary conference room 26(2) through the intermediate conference room 42(2).

In this manner, a connection load can be distributed across as many conference rooms 26, 30, 42 as needed. It should also be understood that other connections and organization schemes may be used. For example, instead of a hierarchy, the conference room interconnections 38 may be established and disconnected dynamically to the different conference rooms 26, 30, 42 as needed, based on the connection load, system resource availability, or other parameters.

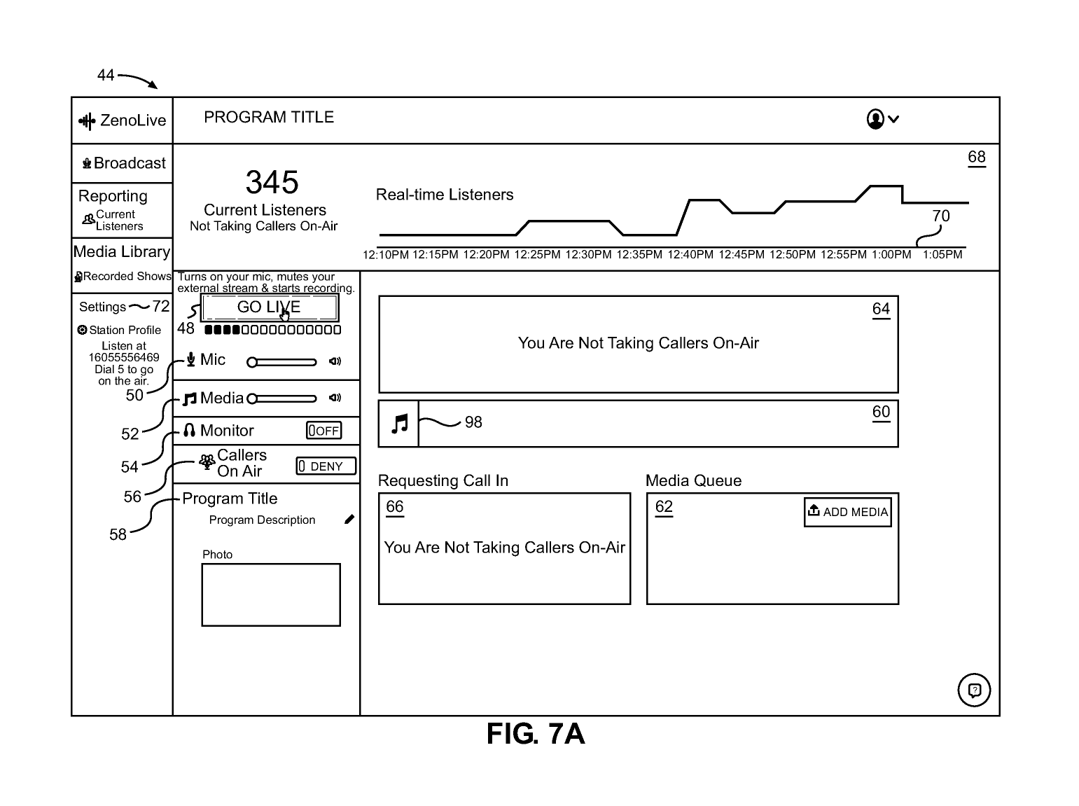

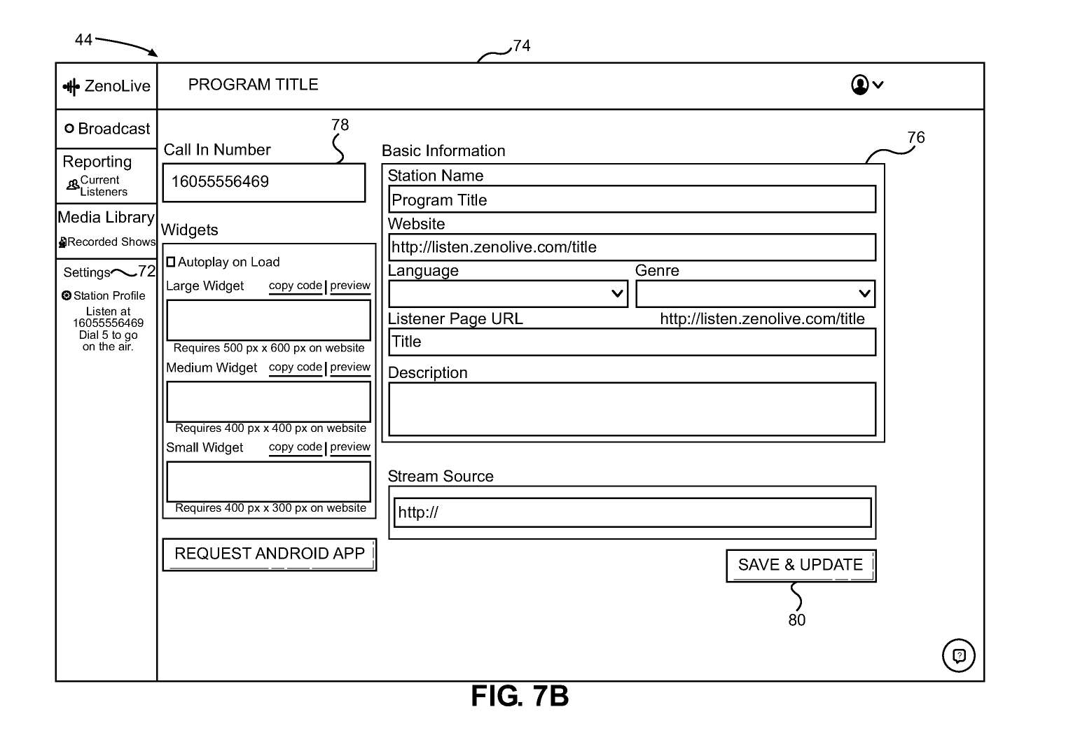

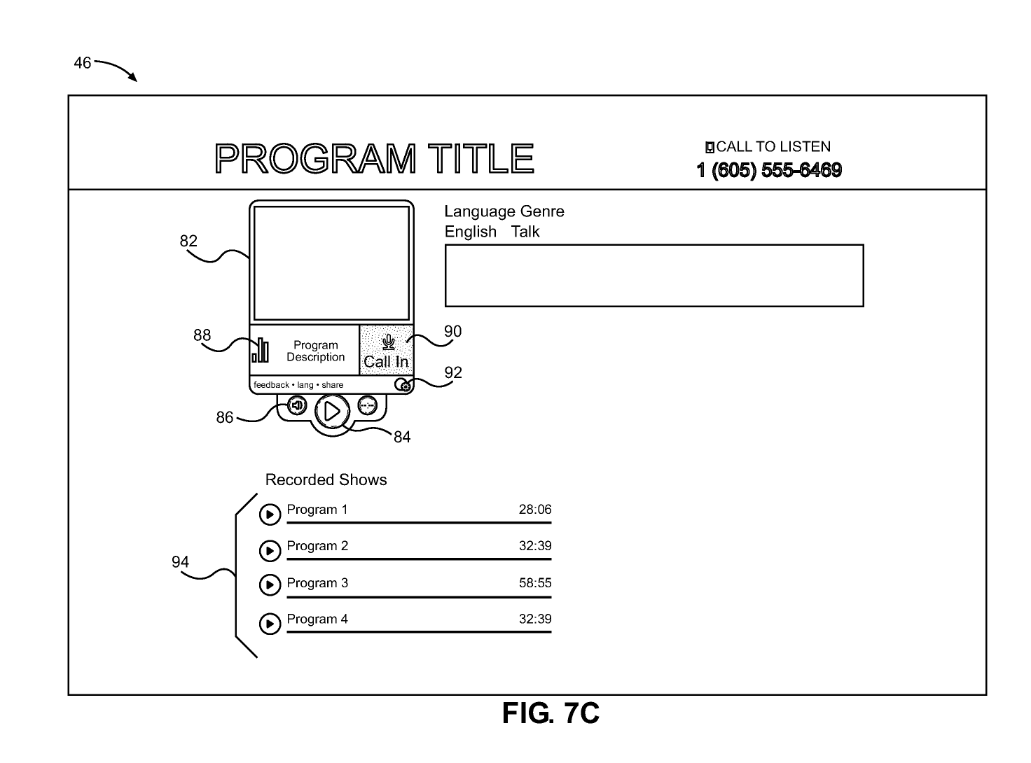

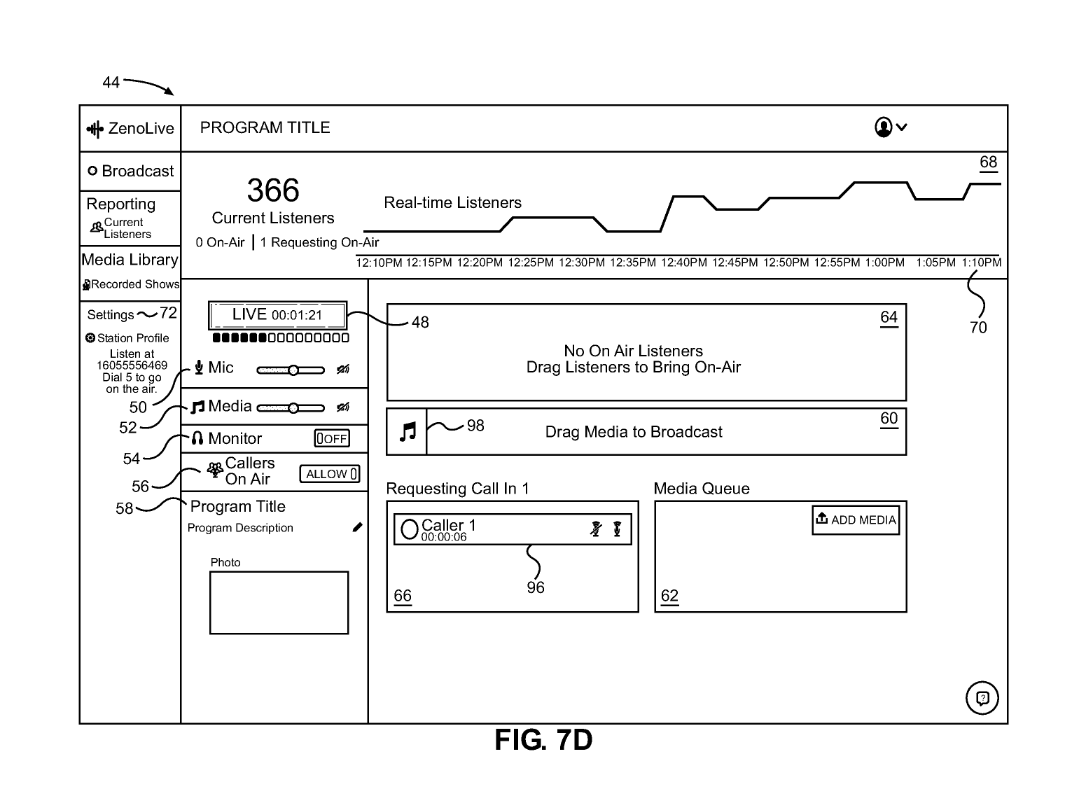

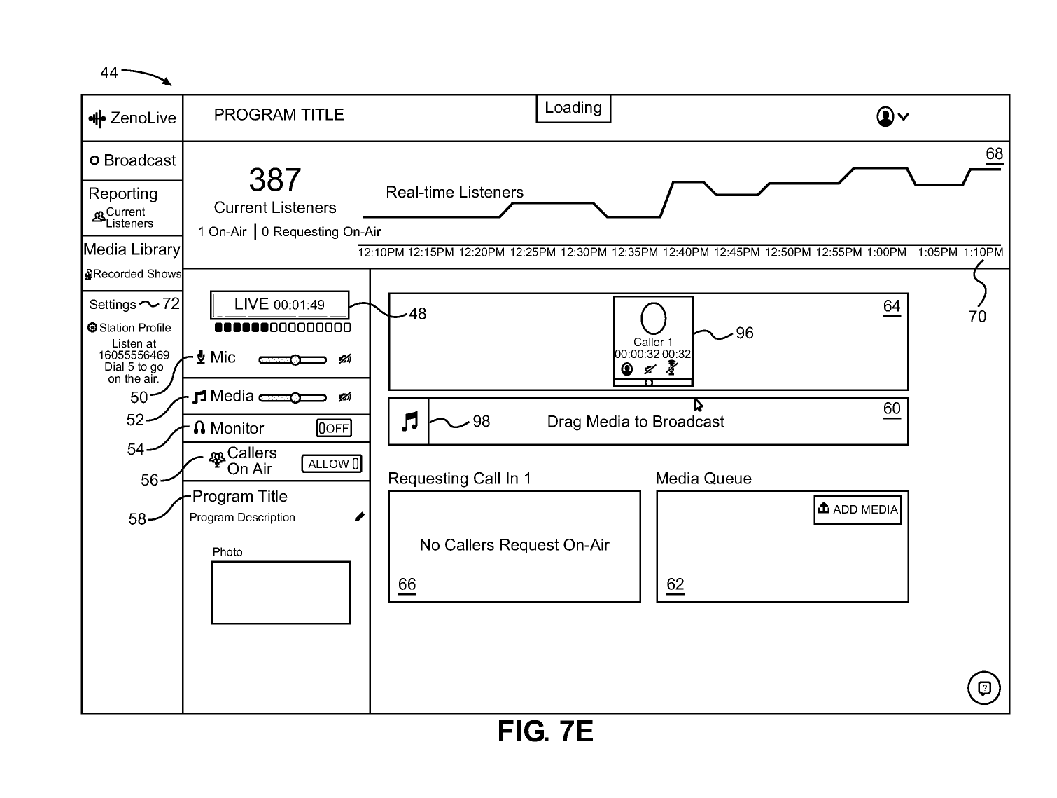

In one embodiment, a user telephony connection 24 may be established by a user calling a phone number, such as a Direct Inward Dialing (DID number), that is pointed to a Voice-over Internet Protocol (VoIP) gateway, which may be the gateway device 12. A user device 18 operated by the listener can be a landline or a mobile phone, for example. The gateway device 12 converts the user signal 22 to a VoIP protocol, such as Session Initiation Protocol (SIP). The gateway device 12 is configured to route the call based on the incoming phone number and/or origin IP address. If a calling card is used, billing may be verified, and the call is then routed to a destination phone number. The source of the broadcast media stream 16 encodes and transmits the broadcast media stream 16, from a host device 32 for example, and may also compress the broadcast media stream 16 before streaming the broadcast media stream 16 to the network 40 or user telephony connections 24. If the user device 18 has permission to connect to the gateway device 12, the gateway device 12 provides a streaming Uniform Resource Locator (URL) that provides access to the broadcast media stream 16. In one embodiment, each user device 18 may get a different, unique, URL. A user is then able to listen to the broadcast media stream 16 using a media player on a user device 18 (described in below with respect to FIG. 7C), such as a computer or smart phone, for example. The media player decompresses the broadcast media stream 16 so that audio can be played through the user device 18.

It is also possible to provide access to multiple radio stations via one phone number. In one embodiment, a user can use a traditional phone to change stations, such as pressing a number for a specific station, or by pressing another key such as the star key, to change stations. In this embodiment, a ZR call server, which may be executing on or in connection with the gateway device 12, recognizes the DID inbound number of the caller, and queries a database to determine which action to perform in response to receiving the number. Based on the DID, the call server provides customized station options in streaming URLs for the individual caller. The call server is also configured to change the streaming URL and/or audio being provided based on, for example, a Dual Tone Multiple Frequency (DTMF) or other message received from a user device 18. In another embodiment, different broadcast media streams 16 may be provided to different extensions of the main number, such that if a different extension is requested, different streaming URL is played.

The telephony conference platform 20 architecture in some embodiments has a number of advantages. For example, a media conversion layer can be configured to convert all audio from media file format such as MP3 to an interactive signal protocol such as SIP before delivering the broadcast media stream 16 to a listener. This has the advantage of requiring all listeners to individually register with the telephony conference platform 20 as an SIP user agent with presence on the telephony conference platform 20 before receiving audio. In another embodiment, the media conversion layer is configured to conference listeners together from various types of user devices 18 and user agents such as smart phone apps using an SIP library, browser originated calls using web RTC, telephone devices running over Public Switched Telephone Network (PSTN), etc. The media conversion layer is configured to collect these different types of calls in a shared conference room 26 based on the originating DID encoded from the respective user devices 18. Another conference room 30, which may be on a different server, is able to call into the first conference room 26 in a talk state. The second conference room 30 may be playing audio, such as an MP3 or WAV file, or a stream source, which plays into the first conference room 26 and is delivered to the respective user devices 18. Determining which callers to put in what conference room 26, 30 is determined by communications between the phone server dial plan and an external database of the telephony conference platform 20. The database of the telephony conference platform 20 is able to record all actions by the various agents on the network, with all actions being logged as IP messages.

Different devices, such as the broadcast host devices 32 or the user devices 18, may interact with the telephony conference platform 20 using different interfaces. In this regard, FIGS. 7A-7E illustrate management of a broadcast using a system similar to the system 10 of FIGS. 1, 4, and 6, with a host device, such as the broadcast host device 32, using a host device user interface 44, and a user or listener device, such as the user device 18, using a listener device user interface 46 (shown in FIG. 7C). Referring now to FIG. 7A, the host device user the host device user interface 44 for a broadcast host device, such as the broadcast host device 32, includes a broadcaster button 48 for initiating, pausing, or terminating a broadcast using the telephony conference platform 20. The host device user interface 44 also includes a microphone volume slider 50 for controlling microphone input sensitivity and volume, and a media volume slider 52, for controlling the input volume of different media included and mixed into the broadcast media stream 16. A monitor switch 54 allows real time monitoring of the broadcast media stream 16, and a caller on-air switch 56 allows the host device to initiate, pause, or terminate the real-time mixing of one or more user signals 22 into the broadcast media stream 16. An information window 58 contains information and media related to the program, such as a program title, program description, background photo, and other information.

The host device user interface 44 also includes an on-air media window 60, and a media queue window 62, for managing media files or streams to be mixed into the broadcast media stream 16. The host device user interface 44 also includes an on-air caller window 64, and a caller queue window 66, for managing incoming calls to be mixed into the broadcast media stream 16. The host device user interface 44 also includes a real-time analytics window 68 that may contain information about the program audience, such as a total number of current listeners or a timeline chart 70 of the number of listeners over time.

The host device user interface 44 also includes a settings button 72, for entering a settings view. In this regard, FIG. 7B illustrates a settings view interface 74 for the user interface FIG. 7A for the broadcast host device 32 according to an embodiment. The settings view interface 74 includes a number of editable information fields 76, such as station/program name, website URL address, language, genre, and program description, for example. The settings view interface 74 also includes a call-in number field 78, for configuring a call-in phone number for accessing the broadcast media stream 16 and/or the call-in features of the program. After editing the settings information, a save/update button 80 applies the changes to the program information, and exits to the main host device user interface 44.

Some or all of these information fields from the settings view interface 74 may be provided to the user device 18, for example, via the telephony conference platform 20, or via the network 40 or other connection. In this regard, FIG. 7C illustrates a listener device user interface 46 for a listener or user device, such as the user device 18, for use with the systems of FIGS. 1, 4, and 6, according to an embodiment. The listener device user interface 46 may be provided as a standalone application to a computing device as a standalone application, such as a personal computer or a smartphone, or may be provided via a webpage as a WebRTC application executing on a remote server. The listener device user interface 46 includes a user widget 82 having user controls such as a play/pause button 84 and volume button 86 for controlling playback of the broadcast media stream 16, as well as a program information display 88 for displaying the program title, description, etc. The listener device user interface 46 also include a call-in button 90 for calling in to the program, a settings button 92 for configuring user or listener settings, and a list of recorded programs 94 that are available for listening via the listener device user interface 46. In some embodiments, the listener device user interface 46 may be capable of using the DTMF and voice channel features for the call-in function, and may use data channels for other interactive features of the listener device user interface 46. In some embodiments as well, a user may be able to share files with the host, such as by uploading files, activate a camera connected to the user device for initiating video chat with the host or another user, and interact with the telephony conference platform in other ways, such as purchasing items, setting up a payment profile, or playing back archived audio.

Pressing the call-in button 90 of the listener device user interface 46 during a live broadcast sends a request to the broadcast host device 32 via the telephony conference platform 20 for the user to be placed in the caller queue. In this regard, FIG. 7D illustrates the host device user interface 44 of FIG. 7A for the broadcast host device 32 receiving a connection request from a user device 18 employing the listener device user interface 46 of FIG. 7C. When a listener initiates a call via the call-in button 90, a caller indicator 96 representing the listener appears in the caller queue window 66 of the host device user interface 44. In this embodiment, the broadcast media stream 16 consists of media represented by a media indicator 98, with no callers mixed into the broadcast media stream 16.

When making its determination, the host device user interface 44 is able to drill down on individual users of the network to see their activity and history in more detail, for example. To accept the caller request, the caller indicator 96 can be dragged from the caller queue window 66 to the on-air caller window 64. In this regard, FIG. 7E illustrates the host device user interface 44 of FIG. 7D placing the user signal 22 received via the listener device user interface 46 into the broadcast media stream 16. In this embodiment, the caller indicator 96 includes additional controls relating to muting, relative volume and other aspects relating to mixing the user signal 22 associated with the caller indicator 96 into the broadcast media stream 16 in real time. In a similar manner, a media indicator 98 or other media can be dragged between the media queue window 62 and the on-air media window 60, to enable or disable mixing different media into the broadcast media stream 16 in real time.

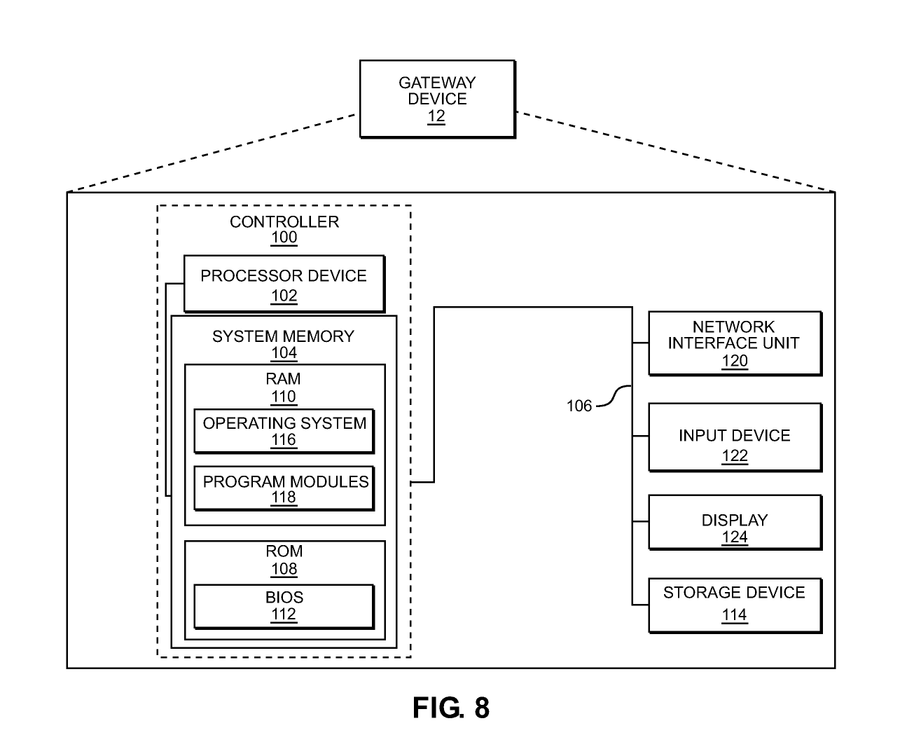

The components and features herein may be embodied in one or more computing devices or computer-readable media having computer-readable instructions, operable for performing methods disclosed herein. In this regard, FIG. 8 illustrates a block diagram for a computing device for use as a gateway device 12 with one of the systems of FIGS. 1, 4, and 6, according to an embodiment. It should be understood, however, that aspects of the computing device described herein may be used in connection with other devices or components, such as, for example, the broadcast host device 32, or user device 18. In this embodiment, the gateway device 12 may comprise any computing or processing device capable of including firmware, hardware, and/or executing software instructions to implement the functionality described herein, and which is capable of being incorporated into components of the gateway device 12. In this example, the gateway device 12 of FIG. 9 includes a controller 100 having a processor device 102, a system memory 104, and a system bus 106. The system bus 106 provides an interface for system components including, but not limited to, the system memory 104 and the processor device 102. The processor device 102 can be any commercially available or proprietary processor.

The system bus 106 may be any of several types of bus structures that may further interconnect to a memory bus (with or without a memory controller), a peripheral bus, and/or a local bus using any of a variety of commercially available bus architectures. The system memory 104 may include non-volatile memory 108 (e.g., read only memory (ROM), erasable programmable read-only memory (EPROM), electrically erasable programmable read-only memory (EEPROM), etc., and/or volatile memory 110 (e.g., random-access memory (RAM). A basic input/output system (BIOS) 112 may be stored in the non-volatile memory 108 and can include the basic routines that help to transfer the information between the elements within the gateway device 12.

The gateway device 12 may further include a computer-readable storage device 114, which may comprise, for example, internal solid state memory, or the like. The computer-readable storage device 114 may provide non-volatile storage of the data, the data structures, the computer-executable instructions, and the like. The data structures can store information relating to, for example, broadcast programs, media, or user information. Computer-executable instructions may include pre-defined data processing instructions, or downloaded instructions for data processing at a specified time or interval, for example.

A number of modules can be stored in the computer-readable storage device 114 and/or in the volatile memory 104, including an operating system 116 and one or more program modules 118, which may implement the functionality described herein in whole or in part.

In addition, the gateway device 12 may include additional components, such as a network interface unit 120 or other communications interface, one or more input devices 122, and a display 124 or other visual indicator interface. The components of the gateway device 12 may interact with other components outside of the gateway device 12, such as a network 40, via the network interface unit 120 or other communications interface.

Those skilled in the art will recognize improvements and modifications to the preferred embodiments of the disclosure. All such improvements and modifications are considered within the scope of the concepts disclosed herein and the claims that follow.

What is claimed is:

1. A method of managing a broadcasting platform comprising:
broadcasting, by a gateway device having a processor, a broadcast media stream to a plurality of user devices connected to a first conference room of a telephony conference platform of the gateway device via a plurality of first user telephony connections each associated with one of the plurality of user devices;
receiving, through the telephony conference platform of the gateway device, a user signal from a first user device of the plurality of user devices via a second user telephony connection associated with a first user device between the first user device and a second conference room of the telephony conference platform;
mixing, through the telephony conference platform of the gateway device, the user signal into the broadcast media stream in real time; and
broadcasting, by the gateway device, the broadcast media stream comprising the user signal to the plurality of user devices connected to the first conference room via the plurality of user telephony connections in real time, excluding the first user device.

2. The method of claim 1, wherein the gateway device comprises a plurality of gateway devices interconnected by a network.

3. The method of claim 2, wherein the network is a cloud-based network.

4. The method of claim 1, wherein broadcasting the broadcast media stream comprises broadcasting the broadcast media stream via a plurality of user telephony connections through the telephony conference platform of the gateway device, each of the plurality of user telephony connections associated with one of the plurality of user devices.

5. The method of claim 1, wherein broadcasting the broadcast media stream comprises broadcasting the broadcast media stream via a plurality of user internet-protocol (IP) connections, each of the plurality of user IP connections associated with one of the plurality of user devices.

6. The method of claim 1, wherein the user signal comprises a media signal.

7. The method of claim 6, wherein the media signal comprises an audio signal.

8. The method of claim 1, further comprising, prior to receiving the user signal, receiving, through the telephony conference platform of the gateway device, a user request associated with the one of the plurality of user devices via the respective user telephony connection.

9. The method of claim 8, further comprising, prior to receiving the user signal, authorizing, by a host device associated with the broadcast media stream in response to the user request, the gateway device to receive the user signal.

10. The method of claim 8, further comprising, prior to mixing the user signal into the broadcast media stream, authorizing, by a host device associated with the broadcast media stream in response to the user request, the gateway device to mix the user signal into the broadcast media stream.

11. A method of managing a broadcasting platform comprising:
directing, by a host device having a processor, a gateway device to broadcast a broadcast media stream to a plurality of user devices connected to a first conference room of a telephony conference platform of the gateway device via a plurality of first user telephony connections each associated with one of the plurality of user devices;
receiving, by the host device through the telephony conference platform of the gateway device, a user signal from a first user device of the plurality of user devices via a second user telephony connection associated with a first user device between the first user device and a second conference room of the telephony conference platform;
directing, by the host device, the telephony conference platform of the gateway device to mix the user signal into the broadcast media stream in real time; and
directing, by the host device, the gateway device to broadcast the broadcast media stream comprising the user signal to the plurality of user devices connected to the first conference room via the plurality of user telephony connections in real time, excluding the first user device.

12. The method of claim 11, wherein the gateway device comprises a plurality of gateway devices interconnected by a network.

13. The method of claim 12, wherein the network is a cloud-based network.

14. The method of claim 11, wherein broadcasting the broadcast media stream by the gateway device comprises broadcasting the broadcast media stream via a plurality of user telephony connections through the telephony conference platform of the gateway device, each of the plurality of user telephony connections associated with one of the plurality of user devices.

15. The method of claim 11, wherein broadcasting the broadcast media stream by the gateway device comprises broadcasting the broadcast media stream via a plurality of user internet-protocol (IP) connections, each of the plurality of user IP connections associated with one of the plurality of user devices.

16. The method of claim 11, wherein the user signal comprises a media signal.

17. The method of claim 16, wherein the media signal comprises an audio signal.

18. The method of claim 11, further comprising, prior to receiving the user signal, receiving, by the host device through the telephony conference platform of the gateway device, a user request associated with the one of the plurality of user devices via the respective user telephony connection.

19. The method of claim 18, further comprising, prior to receiving the user signal, authorizing, by the host device in response to the user request, the gateway device to receive the user signal.

20. The method of claim 18, further comprising, prior to mixing the user signal into the broadcast media stream, authorizing, by the host device in response to the user request, the gateway device to mix the user signal into the broadcast media stream.

21. A gateway device comprising:
a processor; and
a telephony conference platform in communication with the processor, the gateway device configured to:
broadcast a broadcast media stream to a plurality of user devices connected to a first conference room of a telephony conference platform of the gateway device via a plurality of first user telephony connections each associated with one of the plurality of user devices;
receive a user signal from a first user device of the plurality of user devices via a second user telephony connection associated with a first user device between the first user device and a second conference room of the telephony conference platform;
mix the user signal into the broadcast media stream in real time; and
broadcast the broadcast media stream comprising the user signal to the plurality of user devices connected to the first conference room via the plurality of user telephony connections in real time, excluding the first user device.

22. A non-transitory computer-readable medium comprising computer-readable instructions for performing a method of managing a broadcasting platform, the method comprising:
broadcasting, by a gateway device having a processor, a broadcast media stream to a plurality of user devices connected to a first conference room of a telephony conference platform of the gateway device via a plurality of first user telephony connections each associated with one of the plurality of user devices;
receiving, through the telephony conference platform of the gateway device, a user signal from a first user device of the plurality of user devices via a second user telephony connection associated with a first user device between the first user device and a second conference room of the telephony conference platform;
mixing, through the telephony conference platform of the gateway device, the user signal into the broadcast media stream in real time; and
broadcasting, by the gateway device, the broadcast media stream comprising the user signal to the plurality of user devices connected to the first conference room via the plurality of user telephony connections in real time, excluding the first user device.
